(19) United States
(12) Patent Application Publication
(10) Pub. No.: US 2025/0096305 A1
(43) Pub. Date: Mar. 20, 2025

(54) METHOD FOR PREPARING LITHIUM-ION BATTERIES

(71) Applicant: Zhejiang Jinko Energy Storage Co., Ltd., Haining City (CN)

(72) Inventors: Jing CHEN, Haining City (CN); Zixiang YANG, Haining City (CN)

(21) Appl. No.: 18/964,244

(22) Filed: Nov. 29, 2024

(30) Foreign Application Priority Data
Nov. 7, 2024 (CN) 202411586128.0

(51) Int. Cl. H01M 10/0525; H01M 10/0567; H01M 10/0568; H01M 10/0569; H01M 10/058

(52) U.S. Cl. CPC H01M 10/0525; H01M 10/0567; H01M 10/0568; H01M 10/0569; H01M 10/058; H01M 2300/0037

(57) ABSTRACT

Disclosed is a method for preparing lithium-ion batteries including: winding or sheet-stacking a positive electrode sheet, a negative electrode sheet, and a separator, and then placing them into a case to form an initial cell; injecting a first electrolyte into the initial cell, where the first electrolyte includes: 0.5 wt % to 2 wt % vinylene carbonate, 5 wt % to 15 wt % lithium salt, and non-aqueous organic solvent (all by weight); performing a formation process on the initial cell to form an initial solid electrolyte interphase film; injecting a second electrolyte into the initial cell, where the second electrolyte includes: 5 wt % to 20 wt % vinylene carbonate, 5 wt % to 15 wt % lithium salt, 0.005 wt % to 30 wt % infiltrant stabilizer, and non-aqueous organic solvent (all by weight); where the first electrolyte or the second electrolyte further includes: at least one of 1,3-propane sultone or fluoroethylene carbonate.

### CROSS REFERENCE TO RELATED APPLICATIONS

The present application claims the benefit of priority under the Paris Convention to Chinese Patent Application No. 202411586128.0, filed on Nov. 7, 2024, which is incorporated herein by reference in its entirety.

### TECHNICAL FIELD

Embodiments of the present disclosure relate to the technical field of batteries, and in particular to, a method for preparing lithium-ion batteries.

### BACKGROUND

Lithium-ion batteries are currently widely used in electric vehicles, energy storage, electric tools, aerospace, and other fields due to their advantages of high energy density, high voltage, long cycle, and environmental friendliness. Electrolyte, as an important component of the lithium-ion battery system, serves as a bridge connecting the positive and negative electrodes to transmit lithium ions, and is essential to the efficiency of energy transmission of the battery.

To meet the development requirements of high capacity and high energy density, the surface density and press density of the electrode sheets are continuously improved during the battery design process, while the electrolyte injection volume is reduced. Under the condition of low electrolyte injection volume, the low-temperature and long-cycle performance of the battery face further challenges. Especially in the later stages of cycling, the electrolyte may dry up, resulting in a series of performance degradation and sudden performance drop issues.

Therefore, there is an urgent need for a method for preparing lithium-ion batteries that can provide high energy efficiency and long cycle life under the condition of low electrolyte injection volume, so as to meet the complex requirements of the energy storage field.

### SUMMARY

Embodiments of the present disclosure provide a method for preparing lithium-ion batteries, which is beneficial for maintaining high energy efficiency and long cycle life of lithium-ion batteries under the condition of low electrolyte injection volume.

Some embodiments of the present disclosure provide a method for preparing lithium-ion batteries, including: providing a positive electrode sheet, a negative electrode sheet, and a separator; winding or sheet-stacking the positive electrode sheet, the negative electrode sheet, and the separator, and then placing them into a case to form an initial cell, where the separator is positioned between the positive electrode sheet and the negative electrode sheet; injecting a first electrolyte into the initial cell, where the first electrolyte includes: 0.5 wt % to 2 wt % vinylene carbonate, 5 wt % to 15 wt % lithium salt, and non-aqueous organic solvent (all by weight); performing a formation process on the initial cell to form an initial SEI film; injecting a second electrolyte into the initial cell, where the second electrolyte includes: 5 wt % to 20 wt % vinylene carbonate, 5 wt % to 15 wt % lithium salt, 0.005 wt % to 30 wt % infiltrant stabilizer, and non-aqueous organic solvent (all by weight); where the first electrolyte or the second electrolyte further includes: at least one of 1,3-propane sultone or fluoroethylene carbonate, where an amount of 1,3-propane sultone is within a range of 0.1 wt % to 2 wt % by weight, and an amount of fluoroethylene carbonate is within a range of 0.1 wt % to 2 wt % by weight.

In some embodiments, the first electrolyte includes 0.1 wt % to 2 wt % 1,3-propane sultone and 0.1 wt % to 2 wt % fluoroethylene carbonate.

In some embodiments, after performing the formation process on the initial cell and before injecting the second electrolyte into the initial cell, the method further includes: performing a replenishment treatment on the initial cell, where the first electrolyte is replenished into the initial cell.

In some embodiments, before performing the formation process on the initial cell, the method includes: weighing the initial cell to obtain its first mass; and after performing the formation process on the initial cell, the method includes: weighing the initial cell again to obtain its second mass; where the mass of the first electrolyte replenished during the replenishment treatment is the difference between the first mass and the second mass.

In some embodiments, the infiltrant stabilizer is one of poly(ethyleneglycol) 2-[ethyl[(heptadecafluorooctyl)sulfonyl]amino]ethyl ether, 2-(N-Ethylperfluorooctanesulfonamido)ethyl methacrylate, fluorobenzene, 2,2,3,3-tetrafluoro-1-(1,1,2,2-tetrafluoroethoxy)propane, hexafluoropropyl ethylene glycol, and trifluoro(trifluoromethyl)oxirane.

In some embodiments, the first electrolyte includes: at least one of positive electrode film-forming agent or negative electrode film-forming agent, where an amount of the positive electrode film-forming agent is within a range of 0.5 wt % to 3 wt % by weight, and an amount of the negative electrode film-forming agent is within a range of 0.5 wt % to 2 wt % by weight.

In some embodiments, the first electrolyte accounts for 65 wt % to 90 wt % by weight of the total mass of the first electrolyte and the second electrolyte.

In some embodiments, an injection volume of the first electrolyte is within a range of 3.5 g/Ah to 4 g/Ah; and an injection volume of the second electrolyte is within a range of 3.5 g/Ah to 4 g/Ah.

In some embodiments, the formation process includes operations of: first high-temperature standing, negative-pressure formation, and aging standing.

In some embodiments, after injecting the second electrolyte into the initial cell, the method includes: performing a second high-temperature standing process on the initial cell, where the temperature of the second high-temperature standing process is higher than that of the first high-temperature standing process.

The technical solution provided in the embodiments of the present disclosure has at least the following advantages:

The method for preparing lithium-ion batteries provided in the embodiments of the present disclosure utilizes a two-step electrolyte injection technology, comprehensively takes advantages of three additives: vinylene carbonate, 1,3-propane sultone, and fluoroethylene carbonate, and can significantly enhance the overall stability of SEI film and battery performance. Fluoroethylene carbonate is conducive to ensuring low-temperature and high-energy efficiency performance of batteries; 1,3-propane sultone is beneficial for enhancing the compactness and stability of the SEI film, especially providing additional protection under high-temperature conditions; and vinylene carbonate helps maintain and repair the SEI structure during high-temperature cycling. By optimizing the function and application timing of each additive through synergistic effects, the initial performance of the battery is improved, and the battery can maintain excellent cycle stability during long-term use. The two-step electrolyte injection technology successfully achieves an effective balance between low interfacial impedance and long cycle stability of the battery, while maintaining a low total electrolyte usage.

### BRIEF DESCRIPTION OF THE DRAWINGS

One or more embodiments are illustrated through the figures in the corresponding drawings. These exemplary illustrations do not constitute limitations on the embodiments unless otherwise stated. The figures in the accompanying drawings do not constitute a scale limitation. In order to illustrate the technical solutions in the embodiments of the present disclosure or in the conventional technology more clearly, the drawings used in the description of the embodiments are briefly described below. It is apparent that the drawings in the following description show only some embodiments of the present disclosure, and other drawings may be obtained by those of ordinary skill in the art based on these drawings without any creative efforts.

FIG. 1 is a flow chart of a method for preparing lithium-ion batteries provided in the embodiments of the present disclosure;

FIG. 2 is a schematic diagram of the electrochemical structure of a lithium-ion battery provided in the embodiments of the present disclosure;

FIG. 3 shows the formulations of the first electrolyte and the second electrolyte corresponding to Comparative Example 1 and Embodiments 2 to 17 provided in the embodiments of the present disclosure;

FIG. 4 shows the test results corresponding to Comparative Example 1 and Embodiments 2 to 17 provided in the embodiments of the present disclosure.

### DETAILED DESCRIPTION OF THE EMBODIMENTS

As can be seen from the background technology, there is an urgent need for a method for preparing lithium-ion batteries that can provide high energy efficiency and long cycle life under the condition of low electrolyte injection volume, so as to meet the complex requirements of the energy storage field.

Lithium iron phosphate battery is taken as an example for the following description. Currently, additives are commonly added in the electrolyte of lithium iron phosphate batteries to improve the high-temperature performance and lifespan of the lithium iron phosphate batteries. However, these additives generally limit the energy efficiency of lithium iron phosphate batteries at both normal and low temperatures. Although adjusting the electrolyte formulation can improve the energy efficiency at both normal and low temperatures, such solution typically comes at the expense of the performance of lithium iron phosphate batteries in high-temperature environments. For instance, in related technologies, a two-step electrolyte injection method is employed, targeting various additives to strike a balance between high-temperature performance and dynamic performance. However, these methods have not fully considered the special requirements of the energy storage field for battery performance, especially issues related to electrolyte drying and battery performance degradation under the condition of low electrolyte injection volume. In some other related technologies, the two-step electrolyte injection method is employed, where the amount of the high-temperature additive is adjusted at different stages, improving the high-temperature storage performance of the battery. However, there is still room for improvement in terms of energy efficiency at room temperature and low temperatures.

Therefore, it is desirable to ensure good cycle performance of the battery in high-temperature environments, and achieve high energy efficiency and long cycle life of the battery under the condition of low electrolyte injection volume. This necessitates that in the design of the electrolyte, consideration should be given to its performance at different temperatures, and also to the special requirements of batteries under the condition of low electrolyte injection volume, especially at room temperature and low temperatures. The electrolyte needs to exhibit higher energy efficiency and stability to address potential issues arising from low electrolyte injection, such as uneven reactions within the battery and accelerated degradation.

Vinylene carbonate (VC) is an important additive in the electrolyte of lithium iron phosphate batteries. VC can form a dense and uniform SEI (solid electrolyte interphase) film on the surface of the negative electrode, improving the high-temperature cycle performance of lithium iron phosphate batteries. As the long cycle stability of lithium iron phosphate batteries for energy storage becomes a core goal, the amount of VC used in the electrolyte formulation is also increasing. Although VC is important and effective in the lithium iron phosphate system, the SEI film formed by VC has a high impedance, which results in a decrease in battery energy efficiency and low-temperature performance. Such disadvantages contradict the low-temperature and high-energy efficiency requirements of energy storage applications. The contradiction between the requirement for increasing the amount of VC in the electrolyte for long cycles and the requirement for low-temperature and high-energy efficiency performance of the battery is becoming increasingly prominent.

To balance the aforementioned contradiction, a two-step electrolyte injection method is commonly employed to optimize the formation of the SEI film. In the first step, a small amount of VC is injected to generate a uniform film with low impedance. In the second step, a larger amount of VC is injected to precisely and targetedly repair the SEI in the later stages of cycling. Such method can balance the high and low temperature performance requirements of the battery to a certain extent. But the excessive amount of VC injected in the second step may result in dispersion and insufficient infiltration. Such dispersion and insufficient infiltration may result in that the SEI film formed in the later stage is over thick at some portions, which in turn can cause micro-short circuits and undermine the cycle stability of the battery. In addition, the reduction in electrolyte volume under high energy density design also makes this issue more prominent.

The method 100 for preparing lithium-ion batteries provided in the embodiments of the present disclosure utilizes a two-step electrolyte injection technology, comprehensively takes advantages of three additives: vinylene carbonate, 1,3-propane sultone, and fluoroethylene carbonate, and can significantly enhance the overall stability of SEI film and battery performance. Fluoroethylene carbonate is conducive to ensuring low-temperature and high-energy efficiency performance of batteries; 1,3-propane sultone is beneficial for enhancing the compactness and stability of the SEI film, especially providing additional protection under high-temperature conditions; and vinylene carbonate helps maintain and repair the SEI structure during high-temperature cycling. By optimizing the function and application timing of each additive through synergistic effects, the initial performance of the battery is improved, and the battery can maintain excellent cycle stability during long-term use. The two-step electrolyte injection technology successfully achieves an effective balance between low interfacial impedance and long cycle stability of the battery, while maintaining a low total electrolyte usage.

In the description of the embodiments of the present disclosure, technical terms such as “first”, “second”, etc., are merely used for distinguishing different objects and should not be understood as indicating or implying relative importance or implicitly specifying the number, specific order, or priority of the indicated technical features.

In the description of the embodiments of the present disclosure, the term “plurality of” refers to two or more, unless otherwise explicitly specified.

The mention of “embodiment” in this paper means that the specific features, structures, or characteristics described in conjunction with the embodiments may be included in at least one embodiment of the present disclosure. The appearance of this phrase at various locations in the specification does not necessarily refer to the same embodiment, nor is it an independent or alternative embodiment that is exclusive with other embodiments. Those skilled in the art can understand explicitly and implicitly that the embodiments described in this paper can be combined with other embodiments.

In the description of the embodiments of the present disclosure, the term “and/or” merely describes the associative relationship between associated objects, indicating that there can be three types of relationships. For example, A and/or B can represent three possible situations: sole existence of A, existence of both A and B, and sole existence of B. Additionally, the character “/” in this paper generally indicates that the associated objects with this character are in an “or” relationship.

In the description of the embodiments of the present disclosure, when one component “includes” another component, such expression does not exclude other components and other components may also be further included unless otherwise stated.

The terms used in the description of various embodiments mentioned in this paper are solely for the purpose of describing specific embodiments and are not intended to be restrictive. As used in the description of the various embodiments and the appended claims, “component” is also intended to cover the plural form, unless the context clearly indicates otherwise.

The following provides a detailed description of the various embodiments of the present disclosure in conjunction with the accompanying drawings. However, those of ordinary skill in the art may understand that in various embodiments of the present disclosure, many technical details have been presented to facilitate a better understanding of the present disclosure by the reader. However, even without these technical details and the various variations and modifications based on the following embodiments, the technical solution claimed in the present disclosure can still be achieved.

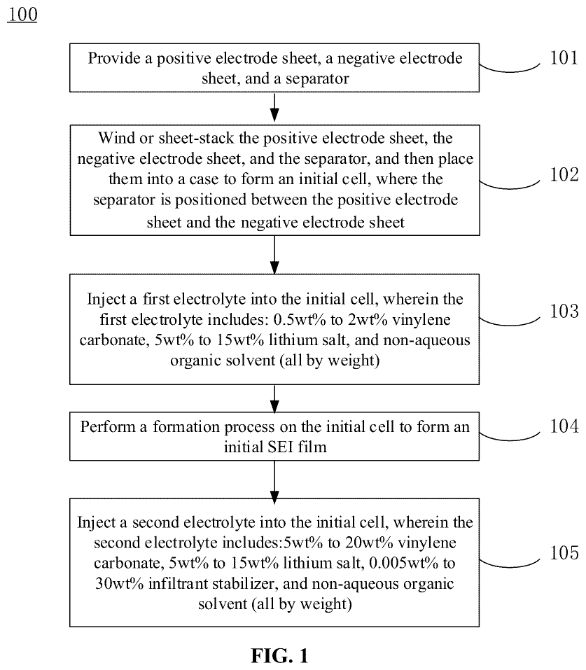

FIG. 1 is a flow chart of a method 100 for preparing lithium-ion batteries provided in the embodiments of the present disclosure.

Referring to FIG. 1, the method 100 for preparing lithium-ion batteries includes the following operations.

In operation 101, a positive electrode sheet, a negative electrode sheet, and a separator are provided.

The positive electrode sheet may comprise a positive electrode current collector and a positive electrode material layer covering the surface of the positive electrode current collector. The positive electrode material layer includes a positive electrode material and a positive electrode binding material, where the positive electrode material is dispersed within the positive electrode binding material.

The negative electrode sheet may comprise a negative electrode current collector and a negative electrode material layer covering the surface of the negative electrode current collector. The negative electrode material layer includes a negative electrode material and a negative electrode binding material, where the negative electrode material is dispersed within the negative electrode binding material.

In a specific example, the material of the positive electrode current collector is aluminum foil, and the material of the negative electrode current collector is copper foil.

The positive electrode material may be selected from lithium iron phosphate, lithium cobaltate, lithium manganate, or ternary materials.

The negative electrode material may be selected from natural graphite, artificial graphite, soft carbon, hard carbon, etc.

Both the positive electrode binding material and the negative electrode binding material may be selected from carboxymethylcellulose sodium, polyvinylidene fluoride or butadiene styrene rubber.

The separator may be selected from polypropylene (PP) microporous separator, polyethylene (PE) microporous separator, PE/PP composite microporous separator, copolymer separator of propylene and ethylene, or polyethylene homopolymer separator, etc.

In operation 102, the positive electrode sheet, the negative electrode sheet, and the separator are wound or sheet-stacked, and then placed into a case to form an initial cell, where the separator is positioned between the positive electrode sheet and the negative electrode sheet.

The winding process involves sequentially laying the positive electrode sheet, the separator, and the negative electrode sheet, and then winding them into a core roll in a specific order. It is mainly used for the production of square and cylindrical lithium batteries.

The sheet-stacking process involves stacking positive electrode sheets, separators, negative electrode sheets layer by layer to construct a cell. The sheet-stacking process may generally be classified into layer-stacking and layer-folding types. Compared to the winding process, the sheet-stacking process requires higher tension control, and is mainly used in the production of large square batteries, ultra-thin batteries, and special-shaped batteries.

In operation 103, a first electrolyte is injected into the initial cell, where the first electrolyte includes: 0.5 wt % to 2 wt % vinylene carbonate, 5 wt % to 15 wt % lithium salt, and non-aqueous organic solvent (all by weight). The first electrolyte, primarily composed of low-concentration additives, facilitates the formation of a less polarized, uniform, and dense SEI film during the subsequent formation process, and effectively discharges side reaction gases. This avoids the issue of insufficient reaction resulting from addition of a large amount of additives all at once. In addition, controlling the combination and proportion of additives can generate a superior interfacial layer, namely the SEI film.

In the first electrolyte, the mass fraction of each component is represented as the proportion of the mass of that component to the total mass of the first electrolyte.

For example, the mass fraction of vinylene carbonate in the first electrolyte is within a range of 0.5 wt % to 2 wt %, indicating that the proportion of the mass of vinylene carbonate to the total mass of the first electrolyte is within a range of 0.5 wt % to 2 wt %, such as 0.5 wt % to 0.8 wt %, 0.8 wt % to 1.2 wt %, 1.2 wt % to 1.6 wt %, or 1.6 wt % to 2 wt %. Specifically, it may be 0.5 wt %, 0.6 wt %, 0.7 wt %, 0.8 wt %, 0.9 wt %, 1.0 wt %, 1.1 wt %, 1.2 wt %, 1.3 wt %, 1.4 wt %, 1.5 wt %, 1.6 wt %, 1.7 wt %, 1.8 wt %, 1.9 wt %, or 2.0 wt %.

For example, the mass fraction of lithium salt in the first electrolyte is within a range of 5 wt % to 15 wt %, indicating that the proportion of the mass of lithium salt to the total mass of the first electrolyte is 5 wt % to 15 wt %, such as 5 wt % to 9.5 wt %, 9.5 wt % to 12 wt %, 12 wt % to 15 wt %. Specifically, it may be 5 wt %, 5.5 wt %, 6 wt %, 6.5 wt %, 7 wt %, 7.5 wt %, 8 wt %, 8.5 wt %, 9 wt %, 9.5 wt %, 10 wt %, 10.5 wt %, 11 wt %, 11.5 wt %, 12 wt %, 12.5 wt %, 13 wt %, 13.5 wt %, 14 wt %, 14.5 wt %, or 15 wt %.

The type of lithium salt may be selected from lithium perchlorate (LiClO4), lithium tetrafluoroborate (LiBF4), lithium hexafluoroarsenate (LiAsF6), and lithium hexafluorophosphate (LiPF6).

In some embodiments, the first electrolyte may further include: at least one of positive electrode film-forming agent or negative electrode film-forming agent.

An amount of the positive electrode film-forming agent may be within a range of 0.1 wt % to 0.3 wt %, 0.3 wt % to 0.5 wt %, 0.5 wt % to 2 wt %, 2 wt % to 3 wt %, 3 wt % to 4 wt %, or 4 wt % to 5 wt %. Specifically, it may be 0.1 wt %, 0.3 wt %, 0.5 wt %, 2 wt %, 2.5 wt %, 3.3 wt %, or 4 wt %.

The positive electrode film-forming agent may be at least one of the following: lithium difluorophosphate, 1,5,2,4-dioxadithiane 2,2,4,4-tetraoxide, 1,3,2-dioxathiolane 2,2-dioxide, prop-1-ene-1,3-sultone, tris(trimethylsilyl) borate, tris(trimethylsilyl) phosphate, 1H-Imidazole-1-carboxylicacid, 2-propynylester(9CI), triallyl isocyanurate, 2,4-toluene diisocyanate, 2-phenyl-1-yl 1H-imidazole-1-sulfonic acid ester, hexamethylene diisocyanate, lithium bis[ethanedioato(2-)-κO1,κO2]difluorophosphate(1-), 2-fluoropyridine, lithium bis (oxalate) borate, or lithium difluoro(oxalato)borate(1-).

An amount of the negative electrode film-forming agent may be within a range of 0.1 wt % to 0.3 wt %, 0.3 wt % to 0.5 wt %, 0.5 wt % to 2 wt %, or 2 wt % to 3 wt %. Specifically, it may be 0.1 wt %, 0.3 wt %, 0.5 wt %, 2 wt %, 2.5 wt %, or 3 wt %.

The negative electrode film-forming agent may be at least one of the following: 1,3,2-dioxathiolane 2,2-dioxide, 1,5,2,4-dioxadithiane 2,2,4,4-tetraoxide, lithium difluoro(oxalato)borate(1-), propylene sulfate, lithium bis[ethanedioato(2-)-κO1,κO2]difluorophosphate(1-), tris(trimethylsilyl) phosphate, lithium bis(oxalato) borate, 1,3-propylene disulfonic acid methyl ester, and trimethylsilyl phosphate.

In some embodiments, the first electrolyte may include 0.5 wt % to 2 wt % vinylene carbonate, 5 wt % to 15 wt % lithium salt, 0.5 wt % to 3 wt % positive electrode film-forming agent, and non-aqueous organic solvent (all by weight); or the first electrolyte may include 0.5 wt % to 2 wt % vinylene carbonate, 5 wt % to 15 wt % lithium salt, 0.5 wt % to 2 wt % negative electrode film-forming agent, and non-aqueous organic solvent (all by weight); or the first electrolyte may include 0.5 wt % to 2 wt % vinylene carbonate, 5 wt % to 15 wt % lithium salt, 0.5 wt % to 3 wt % positive electrode film-forming agent, 0.5 wt % to 2 wt % negative electrode film-forming agent and non-aqueous organic solvent (all by weight).

The non-aqueous organic solvent of the first electrolyte may include two or more of the following: ethyl methyl carbonate, dimethyl carbonate, diethyl carbonate, methyl ethyl carbonate, ethyl acetate, n-propyl acetate, methyl propionate, methyl acetate, ethyl propionate, propyl propionate, ethyl butyrate, methyl propyl carbonate, propylene carbonate, γ-butyrolactone, and γ-valerolactone. In addition, cyclic carboxylic acid esters, chain carboxylic acid esters, ether compounds, and sulfone compounds may also be added to the first electrolyte to optimize its performance and stability.

In a specific example, the non-aqueous organic solvent of the first electrolyte consists of ethylene carbonate, methyl ethyl carbonate, and dimethyl carbonate, where a mass fraction of the ethylene carbonate to non-aqueous organic solvent is 30%, the mass fraction of methyl ethyl carbonate to the non-aqueous organic solvent is 30%, and the mass fraction of dimethyl carbonate to the non-aqueous organic solvent is 40%.

In operation 104, a formation process is performed on the initial cell.

The formation process generally includes: first high-temperature standing, negative-pressure formation, and aging standing.

The temperature of the first high-temperature standing maybe within a range of 45° C. to 60° C., such as 45° C. to 50° C., 50° C. to 55° C., or 55° C. to 60° C. Specifically, it may be 45° C., 48° C., 50° C., 53° C., 56° C., or 60° C. The time duration of the first high-temperature standing may be within a range of 36 h to 72 h, such as 36 h to 45 h, 45 h to 62 h, or 62 h to 72 h. Specifically, it may be 36 h, 38 h, 40 h, 45 h, 50 h, 57 h, 60 h, 66 h, 70 h, or 72 h. Formation at temperatures above 40° C. is high-temperature formation, which can accelerate the rate of electrochemical reactions and the growth of the SEI film, and reduce the time required for formation.

The negative-pressure formation may include a first formation and a second formation. In the first formation, the initial cell is first charged to a state of charge (SOC) of 5% to 10% using a current of 0.01C to 0.1C rate, and then discharged; and in the second formation process step, the initial cell is first charged to a state of charge of 10% to 85% using a current of 0.1C to 0.5C rate, and then discharged. In this way, formation using a small current forms a dense and stable SEI film, the activation time duration of the small current is long but the polarization is small, and the generated SEI film is mostly formed via single-molecule reactions, with dense structure and less irreversible reactions; the subsequent formation using a large current can accelerate the formation of the SEI film and reduce the formation time, but is more prone to two-electron reactions and may generate more inorganic components with a loose structure, which is beneficial for electrolyte infiltration. A stepped formation method can enhance the battery's charging and discharging efficiency, reduce internal resistance, and impart the battery with superior cycle performance by balancing the formation quality of the SEI film and the infiltration effect of the electrolyte.

In the first formation, the current may have a rate within a range of 0.01C to 0.05C, 0.05C to 0.08C, or 0.08C to 0.1C. Specifically, the rate may be 0.01C, 0.05C, 0.08C, or 0.1C; the SOC in the first formation may be within a range of 5% to 7%, 7% to 9%, or 9% to 10%. Specifically, it may be 5%, 6%, 7%, 8%, 9%, or 10%. In the second formation, the current may have a rate within a range of 0.1C to 0.3C, 0.3C to 0.4C, or 0.4C to 0.5C. Specifically, the rate may be 0.1C, 0.25C, 0.38C, 0.46C, or 0.5C; the SOC in the second formation may be within a range of 10% to 25%, 25% to 45%, 45% to 60%, 60% to 80%, or 80% to 85%. Specifically, it may be 10%, 15%, 26%, 34%, 45%, 60%, 73%, 80%, or 85%.

In some embodiments, the time duration of the first formation is controlled to be within a range of 0.5 h to 10 h, such as 0.5 h to 2 h, 2 h to 6 h, 6 h to 8 h, or 8 h to 10 h. Specifically, it may be 0.5 h, 0.8 h, 1 h, 3 h, 5 h, 8 h, or 10 h; the time duration of the second formation is controlled to be within a range of 1.6 h to 8 h, such as 1.6 h to 3 h, 3 h to 5 h, 5 h to 7 h, or 7 h to 8 h. Specifically, it may be 1.6 h, 2 h, 4 h, 5 h, 6 h, or 8 h.

In a specific embodiment, the upper limit voltage for both the first formation and the second formation is set at 3.65V.

The vacuum degree in the negative-pressure formation may be within a range of −10 KPa to −100 KPa, −10 KPa to −20 KPa, −20 KPa to −50 KPa, or −50 KPa to −100 KPa. Specifically, it may be −10 KPa, −20 KPa, −50 KPa, −75 KPa, or −100 KPa.

The temperature of the aging standing maybe within a range of 45° C. to 60° C., such as 45° C. to 50° C., 50° C. to 55° C., or 55° C. to 60° C. Specifically, it may be 45° C., 48° C., 50° C., 53° C., 56° C., or 60° C.; the time thereof may be within a range of 18 h to 24 h, such as 18 h to 20 h, 20 h to 22 h, or 22 h to 24 h. Specifically, it may be 18 h, 19 h, 20 h, 21 h, 22 h, 23 h, or 24 h.

In operation 105, a second electrolyte is injected into the initial cell, where the second electrolyte includes: 5 wt % to 20 wt % vinylene carbonate, 5 wt % to 15 wt % lithium salt, 0.005 wt % to 30 wt % infiltrant stabilizer, and non-aqueous organic solvent (all by weight). The second electrolyte includes an infiltrant stabilizer and a high concentration of vinylene carbonate. The infiltrant stabilizer can enhance the coverage of the electrode, reduce surface tension, improve the wettability of the second electrolyte, and inhibit performance degradation caused by reduced electrolyte. The high-concentration vinylene carbonate can effectively repair the formed SEI film, thereby enhancing the high-temperature performance and cycle life of the cell.

In the second electrolyte, the mass fraction of each component is represented as the proportion of the mass of that component to the total mass of the second electrolyte.

For example, the mass fraction of vinylene carbonate in the second electrolyte is within a range of 5 wt % to 20 wt %, indicating that the proportion of the mass of vinylene carbonate to the total mass of the first electrolyte is within a range of 5 wt % to 20 wt %. Specifically, it may be 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, or 20 wt %.

For example, the mass fraction of lithium salt in the second electrolyte is within a range of 5 wt % to 15 wt %, indicating that the proportion of the mass of lithium salt to the total mass of the first electrolyte is within a range of 5 wt % to 15 wt %. Specifically, it may be 5 wt %, 5.5 wt %, 6 wt %, 6.5 wt %, 7 wt %, 7.5 wt %, 8 wt %, 8.5 wt %, 9 wt %, 9.5 wt %, 10 wt %, 10.5 wt %, 11 wt %, 11.5 wt %, 12 wt %, 12.5 wt %, 13 wt %, 13.5 wt %, 14 wt %, 14.5 wt %, or 15 wt %.

For instance, the mass fraction of the infiltrant stabilizer in the second electrolyte is within a range of 0.005 wt % to 30 wt %, indicating that the proportion of the mass of the infiltrant stabilizer to the total mass of the second electrolyte is within a range of 0.005 wt % to 30 wt %. Specifically, it may be 0.005 wt %, 0.01 wt %, 0.02 wt %, 0.03 wt %, 0.04 wt %, 0.05 wt %, 0.06 wt %, 0.07 wt %, 0.08 wt %, 0.09 wt %, 0.1 wt %, 0.2 wt %, 0.3 wt %, 0.4 wt %, 0.5 wt %, 0.6 wt %, 0.7 wt %, 0.8 wt %, 0.9 wt %, 1 wt %, 1.5 wt %, 2 wt %, 2.5 wt %, 3 wt %, 4 wt % 5 wt % 6 wt %, 7 wt % 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt % or 30 wt %.

The infiltrant stabilizer may be selected from: one of poly(ethyleneglycol) 2-[ethyl[(heptadecafluorooctyl)sulfonyl]amino]ethyl ether, 2-(N-Ethylperfluorooctanesulfonamido)ethyl methacrylate, fluorobenzene, 2,2,3,3-tetrafluoro-1-(1,1,2,2-tetrafluoroethoxy)propane, hexafluoropropyl ethylene glycol, and trifluoro(trifluoromethyl)oxirane. These infiltrant stabilizers can significantly enhance the wettability and stability of the electrolyte through their unique structures and functional properties. For instance, fluorobenzene and 2,2,3,3-tetrafluoro-1-(1,1,2,2-tetrafluoroethoxy)propane can notably improve the stability of the electrolyte and the wettability of the electrode surface, thereby enhancing the overall performance of the battery. In addition, fluorine compounds such as 1,3-dioxane (M-) and its derivatives are used in the electrolyte, which not only improves the wettability of the electrolyte but also forms a stable SEI film on the electrode surface, thereby enhancing the battery's cycle performance and energy efficiency. Reasonably combining these infiltrant stabilizer additives can flexibly adjust the formulation of the second electrolyte to meet the needs of different types of lithium-ion batteries, significantly improving the overall performance and service life of the battery.

The second electrolyte may also include auxiliary additives, the amount of which in the second electrolyte is less than 2 wt % by weight.

The auxiliary additives may be at least one of the following: fluoroethylene carbonate, vinylene carbonate, lithium difluoro(oxalato)borate(1-), lithium difluorophosphate, lithium bis(oxalate) borate, 1,5,2,4-dioxadithiane 2,2,4,4-tetraoxide, 1,3,2-dioxathiolane 2,2-dioxide, triallyl phosphate, 1,3-propane sultone, tripropynyl phosphate, 1,3-propylene sulfonic acid lactone, lithium difluorosulfonyl imide, fluorobenzene, trifluoroethoxyethylene carbonate, citraconic anhydride, difluoroethylene carbonate, succinic anhydride, tris(trimethylsilyl) phosphate, glycol sulfite, and hexamethylene diisocyanate. These film-forming additives and gas-inhibiting additives are beneficial for maintaining the stability of the battery during use.

The non-aqueous organic solvent of the second electrolyte may include two or more of the following: ethyl methyl carbonate, dimethyl carbonate, diethyl carbonate, methyl ethyl carbonate, ethyl acetate, n-propyl acetate, methyl propionate, methyl acetate, ethyl propionate, propyl propionate, ethyl butyrate, methyl propyl carbonate, propylene carbonate, γ-butyrolactone, and γ-valerolactone. In addition, cyclic carboxylic acid esters, chain carboxylic acid esters, ether compounds, and sulfone compounds may also be added to the second electrolyte to optimize its performance and stability.

In a specific example, the non-aqueous organic solvent of the second electrolyte consists of ethylene carbonate, methyl ethyl carbonate, and dimethyl carbonate, where a mass fraction of the ethylene carbonate to non-aqueous organic solvent is 30%, the mass fraction of methyl ethyl carbonate to the non-aqueous organic solvent is 30%, and the mass fraction of dimethyl carbonate to the non-aqueous organic solvent is 40%.

The first electrolyte or the second electrolyte further includes at least one of 1,3-propane sultone and fluoroethylene carbonate. The standard decomposition potential of fluoroethylene carbonate is about 1.0V, which is lower than that of vinylene carbonate (1.11V). Therefore, fluoroethylene carbonate has advantages under low temperature and high power discharge conditions, which is conducive to forming a stable SEI film. The decomposition potential of 1,3-propane sultone lies between that of fluoroethylene carbonate and vinylene carbonate. Moreover, 1,3-propane sultone provides moderate interfacial protection for the components of the SEI film, which helps enhance the performance and lifespan of the battery during high-temperature storage and cycling.

An amount of 1,3-propane sultone is within a range of 0.1 wt % to 2 wt % by weight, and an amount of fluoroethylene carbonate is within a range of 0.1 wt % to 2 wt % by weight. The specific embodiments are as follows.

In a first specific embodiment, the first electrolyte may include 0.5 wt % to 2 wt % vinylene carbonate, 5 wt % to 15 wt % lithium salt, 0.1 wt % to 2 wt % 1,3-propane sultone, and non-aqueous organic solvent (all by weight); the second electrolyte may include 5 wt % to 20 wt % vinylene carbonate, 5 wt % to 15 wt % lithium salt, 0.005 wt % to 30 wt % infiltrant stabilizer, and non-aqueous organic solvent (all by weight).

In a second specific embodiment, the first electrolyte may include 0.5 wt % to 2 wt % vinylene carbonate, 5 wt % to 15 wt % lithium salt, 0.1 wt % to 2 wt % fluoroethylene carbonate, and non-aqueous organic solvent (all by weight); the second electrolyte may include 5 wt % to 20 wt % vinylene carbonate, 5 wt % to 15 wt % lithium salt, 0.005 wt % to 30 wt % infiltrant stabilizer, and non-aqueous organic solvent (all by weight).

In a third specific embodiment, the first electrolyte may include 0.5 wt % to 2 wt % vinylene carbonate, 5 wt % to 15 wt % lithium salt, 0.1 wt % to 2 wt % 1,3-propane sultone, 0.1 wt % to 2 wt % fluoroethylene carbonate, and non-aqueous organic solvent (all by weight); the second electrolyte may include 5 wt % to 20 wt % vinylene carbonate, 5 wt % to 15 wt % lithium salt, 0.005 wt % to 30 wt % infiltrant stabilizer, and non-aqueous organic solvent (all by weight). In the first electrolyte, the combined effect of fluoroethylene carbonate and 1,3-propane sultone not only pretreats the electrode interface and forms a stable SEI film, but also facilitates the removal of by-products of the redox reactions in the first electrolyte and reduces initial polarization, avoiding the problem of a sharp increase in interfacial impedance caused by the use of a large amount of vinylene carbonate.

In a fourth specific embodiment, the first electrolyte may include 0.5 wt % to 2 wt % vinylene carbonate, 5 wt % to 15 wt % lithium salt, and non-aqueous organic solvent (all by weight); the second electrolyte may include 5 wt % to 20 wt % vinylene carbonate, 5 wt % to 15 wt % lithium salt, 0.005 wt % to 30 wt % infiltrant stabilizer, 0.1 wt % to 2 wt % 1,3-propane sultone, and non-aqueous organic solvent (all by weight).

In a fifth specific embodiment, the first electrolyte may include 0.5 wt % to 2 wt % vinylene carbonate, 5 wt % to 15 wt % lithium salt, and non-aqueous organic solvent (all by weight); the second electrolyte may include 5 wt % to 20 wt % vinylene carbonate, 5 wt % to 15 wt % lithium salt, 0.005 wt % to 30 wt % infiltrant stabilizer, 0.1 wt % to 2 wt % fluoroethylene carbonate, and non-aqueous organic solvent (all by weight).

In a sixth specific embodiment, the first electrolyte may include 0.5 wt % to 2 wt % vinylene carbonate, 5 wt % to 15 wt % lithium salt, and non-aqueous organic solvent (all by weight); the second electrolyte may include 5 wt % to 20 wt % vinylene carbonate, 5 wt % to 15 wt % lithium salt, 0.005 wt % to 30 wt % infiltrant stabilizer, 0.1 wt % to 2 wt % 1,3-propane sultone, 0.1 wt % to 2 wt % fluoroethylene carbonate, and non-aqueous organic solvent (all by weight).

When 1,3-propane sultone is added to the first electrolyte, the mass fraction of 1,3-propane sultone in the first electrolyte is within a range of 0.1 wt % to 2 wt % based on the total mass of the first electrolyte. When 1,3-propane sultone is added to the second electrolyte, the mass fraction of 1,3-propane sultone in the second electrolyte is within a range of 0.1 wt % to 2 wt % based on the total mass of the second electrolyte. The mass fraction of 1,3-propane sultone in the corresponding first electrolyte or second electrolyte may specifically be 0.1 wt %, 0.2 wt %, 0.3 wt %, 0.4 wt %, 0.5 wt %, 0.6 wt %, 0.7 wt %, 0.8 wt %, 0.9 wt %, 1.0 wt %, 1.1 wt %, 1.2 wt %, 1.3 wt %, 1.4 wt %, 1.5 wt %, 1.6 wt %, 1.7 wt %, 1.8 wt %, 1.9 wt % or 2.0 wt %.

When fluoroethylene carbonate is added to the first electrolyte, the mass fraction of fluoroethylene carbonate in the first electrolyte is within a range of 0.1 wt % to 2 wt % based on the total mass of the first electrolyte. When fluoroethylene carbonate is added to the second electrolyte, the mass fraction of fluoroethylene carbonate in the second electrolyte is within a range of 0.1 wt % to 2 wt % based on the total mass of the second electrolyte. The mass fraction of fluoroethylene carbonate in the corresponding first electrolyte or second electrolyte may specifically be 0.1 wt %, 0.2 wt %, 0.3 wt %, 0.4 wt %, 0.5 wt %, 0.6 wt %, 0.7 wt %, 0.8 wt %, 0.9 wt %, 1.0 wt %, 1.1 wt %, 1.2 wt %, 1.3 wt %, 1.4 wt %, 1.5 wt %, 1.6 wt %, 1.7 wt %, 1.8 wt %, 1.9 wt % or 2.0 wt %.

It is understandable that when the quantity of additives in the first electrolyte varies, the total mass of the corresponding first electrolyte varies, and the mass of different additives needs to be adjusted accordingly based on the aforementioned ratio. When the quantity of additives in the second electrolyte varies, the total mass of the corresponding first electrolyte varies, and the mass of different additives needs to be adjusted accordingly based on the aforementioned ratio.

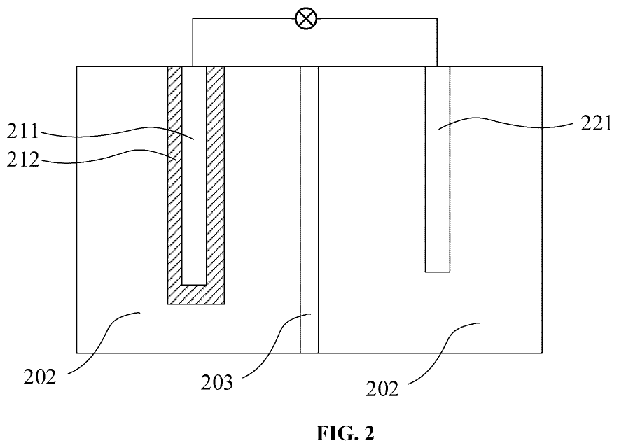

FIG. 2 is a schematic diagram of the electrochemical structure of a lithium-ion battery provided in the embodiments of the present disclosure. FIG. 2 is an electrochemical schematic diagram for ease of explanation of the working principle of lithium-ion batteries, rather than a structural diagram of an actual lithium-ion battery product.

SEI film 212 refers to an interface film deposited on the surface of negative electrode 211 during the first charging process of the lithium-ion battery due to the oxidation-reduction decomposition of electrolyte 202. The SEI film 212 possessing properties of ionic conductivity and electronic insulation serves as a guarantee for the long-term stable operation of lithium-ion batteries, and is key to capacity, rate, cycling, and safety performance.

The working principle of lithium-ion batteries is as follows. During the charging process of lithium-ion batteries, after the lithium ions in the lithium iron phosphate in the positive electrode 221 deintercalate, the lithium iron phosphate transforms into iron phosphate. Under the action of electric field force, the deintercalated lithium ions enter the electrolyte 202 from the surface of the positive electrode 221, pass through the separator 203, and migrate to the surface of the negative electrode 211, where they then intercalate into the crystal lattice of the negative electrode 211 material. During the discharging process of lithium-ion batteries, lithium ions within the crystal lattice of the negative electrode 211 material deintercalate, enter the electrolyte 202, pass through the separator 203, migrate to the surface of the positive electrode 221 and then re-intercalate into the crystal lattice of iron phosphate, transforming iron phosphate into lithium iron phosphate. Oxidation-reduction reactions continuously occur in the charging and discharging processes of lithium-ion batteries, and the compactness and stability of the SEI film are crucial to the performance of lithium-ion batteries.

The method 100 for preparing lithium-ion batteries provided in the embodiments of the present disclosure utilizes a two-step electrolyte injection technology, comprehensively takes advantages of three additives: vinylene carbonate, 1,3-propane sultone, and fluoroethylene carbonate, and can significantly enhance the overall stability of SEI film and battery performance. Fluoroethylene carbonate is conducive to ensuring low-temperature and high-energy efficiency performance of batteries; 1,3-propane sultone is beneficial for enhancing the compactness and stability of the SEI film, especially providing additional protection under high-temperature conditions; and vinylene carbonate helps maintain and repair the SEI structure during high-temperature cycling. By optimizing the function and application timing of each additive through synergistic effects, the initial performance of the battery is improved, and the battery can maintain excellent cycle stability during long-term use. The two-step electrolyte injection technology successfully achieves an effective balance between low interfacial impedance and long cycle stability of the battery, while maintaining a low total electrolyte usage.

In some embodiments, after injecting the second electrolyte into the initial cell, the method 100 includes: performing a second high-temperature standing process on the initial cell, where the temperature of the second high-temperature standing process is higher than that of the first high-temperature standing process. The purpose of the first high-temperature standing process is to facilitate the formation process. To facilitate the formation of the SEI film under more stable conditions and further enhance its compactness and stability, the temperature of the first high-temperature standing process is lower than the temperature of the second high-temperature standing process. After injecting the second electrolyte, to improve the efficiency of battery preparation and simultaneously utilize the second electrolyte to modify the SEI film, the temperature of the second high-temperature standing process can be relatively high.

The temperature of the second high-temperature standing process maybe within a range of 45° C. to 60° C., such as 45° C. to 50° C., 50° C. to 56° C., or 56° C. to 60° C. Specifically, it may be 46° C., 48° C., 50° C., 56° C., or 60° C.

In some embodiments, the first electrolyte accounts for 65 wt % to 90 wt % by weight of the total mass of the first electrolyte and the second electrolyte, for example, 65 wt % to 73 wt %, 73 wt % to 82 wt %, or 82 wt % to 90 wt %. Specifically, the mass fraction may be 65 wt %, 68 wt %, 73 wt %, 78 wt %, 82 wt %, 85 wt %, or 90 wt %. To ensure optimal performance of the cell, the first electrolyte should account for 65 wt % to 90 wt % of the total electrolyte mass. If the injection volume of the first electrolyte in the first electrolyte injection is insufficient, the cell may not be fully infiltrated, which may lead to lithium precipitation issues after the formation process. If the injection volume of the first electrolyte in the first electrolyte injection is too large, the concentration of additives in the second electrolyte injection is excessively high, resulting in nonuniform concentration of additives inside the core roll. Therefore, the injection volume of the first electrolyte in the first electrolyte injection is preferably controlled to be within a range of 70 wt % to 90 wt % of the total volume, thereby improving the consistency of the battery.

In some embodiments, the injection volume of the first electrolyte is within a range of 3.5 g/Ah to 4 g/Ah, for example, 3.5 g/Ah to 3.7 g/Ah, 3.7 g/Ah to 3.8 g/Ah, 3.8 g/Ah to 3.9 g/Ah, or 3.9 g/Ah to 4 g/Ah. Specifically, the injection volume may be 3.5 g/Ah, 3.6 g/Ah, 3.7 g/Ah, 3.8 g/Ah, 3.9 g/Ah, or 4 g/Ah. The injection volume of the second electrolyte is within a range of 3.5 g/Ah to 4 g/Ah, for example, 3.5 g/Ah to 3.7 g/Ah, 3.7 g/Ah to 3.8 g/Ah, 3.8 g/Ah to 3.9 g/Ah, or 3.9 g/Ah to 4 g/Ah. Specifically, the injection volume may be 3.5 g/Ah, 3.6 g/Ah, 3.7 g/Ah, 3.8 g/Ah, 3.9 g/Ah, or 4 g/Ah. Due to the continuous oxidation-reduction reactions occurring on the positive and negative electrodes during the operation of lithium batteries, an insufficient injection volume of electrolyte is detrimental to the cycle life of lithium-ion batteries. Furthermore, an insufficient injection volume of electrolyte prevents some active materials from infiltrating, which is not conducive to expanding the capacity of lithium battery. However, an excessive injection volume of electrolyte can also cause problems such as a decrease in energy density and an increase in cost of lithium-ion batteries. Therefore, the injection volumes of both the first electrolyte and the second electrolyte need to be within an appropriate range.

In some embodiments, after performing the formation process on the initial cell and before injecting the second electrolyte into the initial cell, the method 100 further includes: performing a replenishment treatment on the initial cell, where the first electrolyte is replenished into the initial cell. There is loss of the first electrolyte during the formation process, so a replenishment treatment is performed before injecting the second electrolyte. The replenishment of the first electrolyte is beneficial to ensuring that the ratio of the first electrolyte to the second electrolyte is consistent, thereby enhancing the stability and consistency of the battery.

During the replenishment treatment process, the mass of the replenished first electrolyte may be equivalent to the weight loss of the initial cell in the formation process. The specific operations include the following. Before performing the formation process on the initial cell, the method 100 includes: weighing the initial cell to obtain its first mass; and after performing the formation process on the initial cell, the method 100 includes: weighing the initial cell again to obtain its second mass; where the mass of the first electrolyte replenished during the replenishment treatment is the difference between the first mass and the second mass. Measuring the weight loss of the initial cell during the formation process and then replenishing the same weight of first electrolyte into the initial cell ensures that the total amount of first electrolyte in the cell is restored to the level after injecting the first electrolyte. This can compensate for the loss of the first electrolyte due to evaporation and reaction consumption during the formation process, ensure the consistent ratio of the first electrolyte to the second electrolyte, and maintain the stability of the overall electrolyte formulation.

The method 100 for preparing lithium-ion batteries provided in the embodiments of the present disclosure utilizes a two-step electrolyte injection technology, comprehensively takes advantages of three additives: vinylene carbonate, 1,3-propane sultone, and fluoroethylene carbonate, and can significantly enhance the overall stability of SEI film and battery performance. Fluoroethylene carbonate is conducive to ensuring low-temperature and high-energy efficiency performance of batteries; 1,3-propane sultone is beneficial for enhancing the compactness and stability of the SEI film, especially providing additional protection under high-temperature conditions; and vinylene carbonate helps maintain and repair the SEI structure during high-temperature cycling. By optimizing the function and application timing of each additive through synergistic effects, the initial performance of the battery is improved, and the battery can maintain excellent cycle stability during long-term use. The two-step electrolyte injection technology successfully achieves an effective balance between low interfacial impedance and long cycle stability of the battery, while maintaining a low total electrolyte usage.

The following are specific embodiments of the present disclosure.

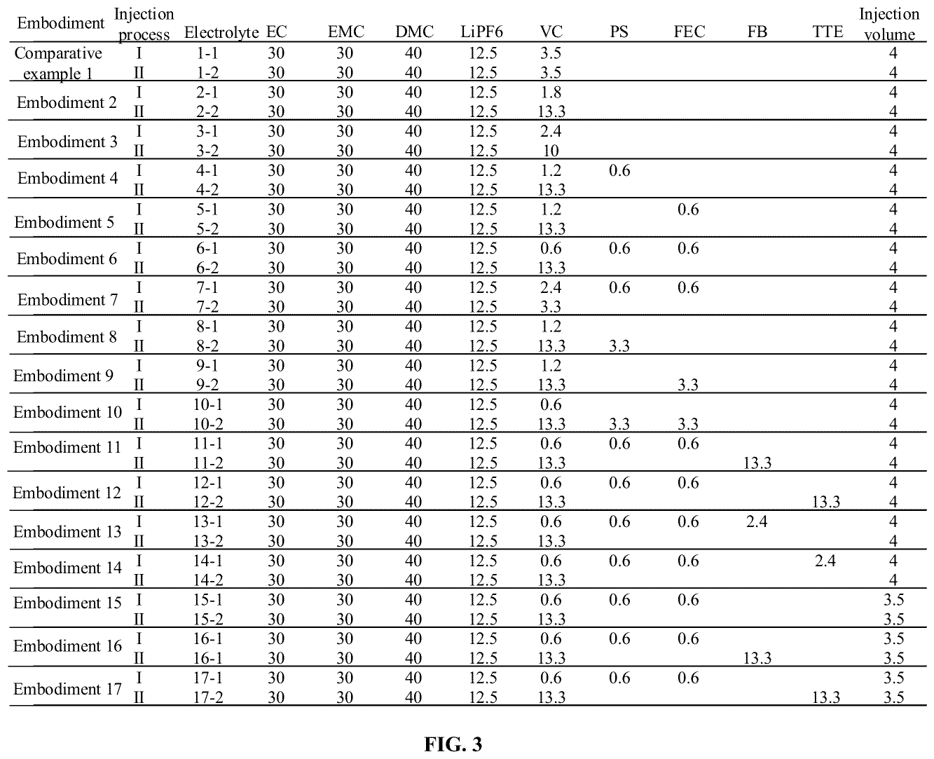

FIG. 3 shows the formulations of the first electrolyte and the second electrolyte corresponding to Comparative Example 1 and Embodiments 2 to 17 provided in the embodiments of the present disclosure. Here, I refers to the first electrolyte injection, and II refers to the second electrolyte injection; EC stands for ethylene carbonate (a non-aqueous organic solvent); EMC stands for methyl ethyl carbonate (a non-aqueous organic solvent); DMC stands for dimethyl carbonate (a non-aqueous organic solvent); LiPF6 stands for lithium hexafluorophosphate (an lithium salt); VC stands for vinylene carbonate (an additive); PS stands for 1,3-propane sultone (an additive); FEC stands for fluoroethylene carbonate (an additive); FB stands for fluorobenzene (an infiltrant stabilizer); TTE stands for 2,2,3,3-Tetrafluoro-1-(1,1,2,2-tetrafluoroethoxy)propane (an infiltrant stabilizer). The unit for the electrolyte injection volume is g/Ah.

For illustrative purposes, in FIG. 3, the solvent is presented as a mass percentage of the solvent, and the remaining lithium salt and additives are presented as mass percentages of the entire formulation. Specifically, taking the mass of the first electrolyte being 100 g as an example, the calculation method for the mass of EC in the first electrolyte in Comparative Example 1 is as follows: (100-mass of additives-mass of lithium salt)×30%, where the mass of additives is 3.5%×100 g=3.5 g, and the mass of lithium salt is 12.5%×100 g=12.5 g. Therefore, the mass of EC in the first electrolyte is (100-3.5-12.5)×30%=25.2 g. The calculation method for the first electrolyte or second electrolyte in other examples is similar.

Referring to FIG. 3, the following method was used to prepare Comparative Example 1 and Embodiments 2 to 17. The specific preparation steps are as follows.

In operation 201, a positive electrode sheet, a negative electrode sheet, and a separator are provided.

The positive electrode sheet includes an aluminum foil and a positive electrode material layer covering the aluminum foil. The positive electrode material layer is composed of lithium iron phosphate, conductive agent SuperP, carbon nanotubes (CNT), and polyvinylidene fluoride (PVDF) in a mass ratio of 95.8:1:0.7:2.5. The negative electrode sheet includes a copper foil and artificial graphite covering the copper foil.

The surface density of the positive electrode sheet is 452 g/m2, and the press density is 2.5 g/cm3. The surface density of the negative electrode sheet is 215 g/m2, and the press density is 1.62 g/cm3.

In operation 202, the positive electrode sheet, the negative electrode sheet, and the separator are wound or sheet-stacked, and then placed into an aluminum plastic film case to form an initial cell, where the separator is positioned between the positive electrode sheet and the negative electrode sheet. After high-temperature baking, the initial cell undergoes moisture testing and helium leak insulation testing.

In operation 203, a first electrolyte is injected into the initial cell, where the composition of the first electrolyte corresponds to X-1 in FIG. 3, and X corresponds to the numbering of Comparative Example 1 or Embodiments 2 to 17.

In operation 204, a formation process is performed on the initial cell. The formation process includes: first high-temperature standing, where the temperature of the high-temperature standing is 45° C. and the time thereof is 36 h; first formation, where the initial cell is first charged to a SOC of 10% using a current of 0.05C rate and then discharged, and the upper limit voltage is 3.65V; second formation, where the initial cell is first charged to a SOC of 85% using a current of 0.25C rate and then discharged, and the upper limit voltage is 3.65V; and aging standing, where the temperature of the aging standing is 45° C. and the time thereof is 18 h.

In operation 205, a replenishment treatment is performed on the initial cell, where the mass of the replenished first electrolyte is equivalent to the weight loss of the initial cell in the formation process.

In operation 206, a second electrolyte is injected into the initial cell, where the composition of the second electrolyte corresponds to Y-1 in FIG. 1, and Y corresponds to the numbering of Comparative Example 1 or Embodiments 2 to 17.

In operation 207, a second high-temperature standing process is performed on the initial cell, where the temperature of the second high-temperature standing process is 50° C., and the time thereof is 36 h.

The following tests were conducted on the aforementioned Comparative Example 1 and Embodiments 2 to 17:

(1) Surface tension test: Fully mix the first electrolyte and the second electrolyte corresponding to each example in a mass ratio of 85:15 to obtain a mixed solution. At 25° C., measure the surface tension of the mixed solution using a surface tensiometer. Surface tension is a measure of the mutual attraction between molecules on the surface of a liquid, typically expressed in newtons per meter (N/m). The lower the surface tension, the better the wettability of the electrolyte, which is conducive to improving the overall performance of the battery.

(2) Infiltrating time test: Fully mix the first electrolyte and the second electrolyte corresponding to each example in a mass ratio of 85:15 to obtain a mixed solution, drop the mixed solution onto the surface of the negative electrode sheet, and test the time it takes for the mixed solution to disappear. The shorter the infiltrating time, the better the wettability of the mixed solution.

(3) Test of cycle capacity retention at 25° C.: At 25° C., charge the lithium-ion batteries corresponding to each example at a constant current of 1C to the upper voltage limit, then charge the batteries at a constant voltage until the current reaches 0.05C, finally discharge the batteries at a constant current of 1C to the lower voltage limit, repeat this cycling charge-discharge test 1000 times, and record the discharge capacity at the 500th cycle and the discharge capacity at the 1000th cycle. The capacity retention rate at the 500th cycle=(discharge capacity at the 500th cycle/discharge capacity at the first cycle)×100%. The capacity retention rate at the 1000th cycle=(discharge capacity at the 1000th cycle/discharge capacity at the first cycle)×100%.

(4) Test of cycle capacity retention at 45° C.: At 45° C., charge the lithium-ion batteries corresponding to each example at a constant current of 1C to the upper voltage limit, then charge the batteries at a constant voltage until the current reaches 0.05C, finally discharge the batteries at a constant current of 1C to the lower voltage limit, repeat this cycling charge-discharge test 1000 times, and record the discharge capacity at the 500th cycle and the discharge capacity at the 1000th cycle. The capacity retention rate at the 500th cycle=(discharge capacity at the 500th cycle/discharge capacity at the first cycle)×100%. The capacity retention rate at the 1000th cycle=(discharge capacity at the 1000th cycle/discharge capacity at the first cycle)×100%.

(5) High-temperature storage performance test at 45° C.: At 45° C., charge the lithium-ion batteries corresponding to each example at a constant current of 1C to the upper voltage limit, then charge the batteries at a constant voltage until the current reaches 0.05C, finally discharge the batteries at a constant current of 1C to the lower voltage limit, and record the discharge capacity of this cycle as the initial capacity C1. Charge the batteries again with a constant current of 1C to the upper voltage limit, then charge the batteries at a constant voltage until the current reaches 0.05C, store the fully charged batteries at 45° C. for 15 days. After the storage period is due, rest the batteries at room temperature for at least 2 hours. Then, discharge the batteries at a constant current of 1C to the lower voltage limit. Record the discharge capacity C2. The capacity retention rate (%)=(C2/C1)×100%. Then, charge the batteries at a constant current and constant voltage of 1C at room temperature until the voltage reaches the upper voltage limit and the current reaches 0.05C. Discharge at a constant current of 1C to the lower voltage limit, and record the recovery capacity C3. The capacity recovery rate (%)=(C3/C1)×100%.

(6) Energy efficiency test: At 25° C., charge the lithium-ion batteries corresponding to each example at a constant power of 0.5P to the upper voltage limit, rest the batteries for 30 minutes, discharge the batteries at a constant power of 0.5P to the lower voltage limit, and rest the batteries for another 30 minutes. The energy efficiency=discharged energy/charged energy.

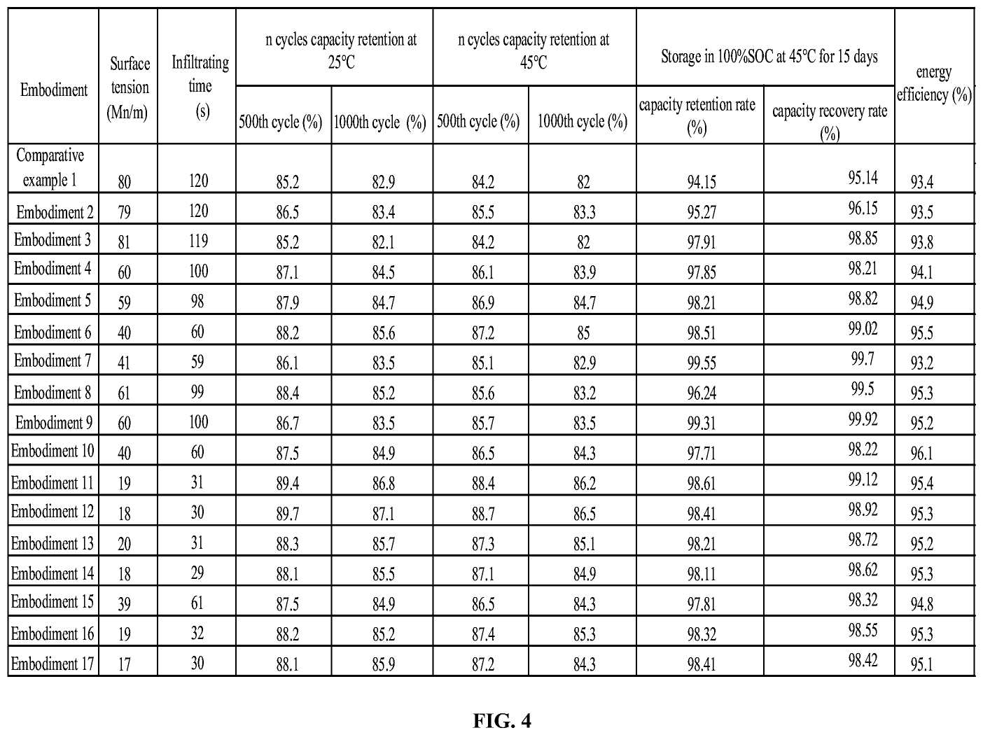

FIG. 4 shows the test results corresponding to Comparative Example 1 and Embodiments 2 to 17 provided in the embodiments of the present disclosure.

In the surface tension test and infiltrating time test, for Comparative Example 1 and Embodiments 2 to 17, a mixed electrolyte was obtained by precisely mixing the first electrolyte with the second electrolyte in a mass ratio of 85:15. The batteries corresponding to Comparative Example 1, Embodiment 2, and Embodiment 3 had the same final comprehensive electrolyte chemical composition as the mixed electrolyte. The experimental results indicate that, without considering the electrochemical reactions within the batteries, formulations of the same composition exhibit highly consistent physical characteristics. This consistency is evident in the essentially identical test results for surface tension and infiltrating time. This phenomenon has been verified in various combinations, such as combination of Comparative Example 1/Embodiment 2/Embodiment 3, Embodiment 4/Embodiment 5/Embodiment 8/Embodiment 9, Embodiment 6/Embodiment 7/Embodiment 10/Embodiment 15, and Embodiment 11/Embodiment 12/Embodiment 13/Embodiment 14/Embodiment 16/Embodiment 17. By comparing Comparative Example 1, Embodiment 2, and Embodiment 3 with other formulation combinations, the introduction of additives and infiltrant stabilizers can both improve the surface tension characteristics of the mixed electrolyte and shorten the infiltrating time. Notably, the effect of the infiltrant stabilizer is prominent, thereby effectively enhancing the overall wetting ability of the electrolyte.

Through four key indicators, namely, the test of cycle capacity retention at 25° C. (ambient temperature cycle test), the test of cycle capacity retention at 45° C. (high temperature cycle test), the high-temperature storage performance test at 45° C. (high temperature storage test), and the energy efficiency test, the impact of electrolyte formulation and injection method on battery performance was deeply explored. The experimental results indicate that the two-step electrolyte injection technology (Embodiment 2 compared to Comparative Example 1) exhibits significant advantages in enhancing various performance indicators of the battery, particularly in improving the capacity retention rate during the later stages of cycling. This phenomenon can be attributed to the targeted repair effect of high-concentration vinylene carbonate in the second electrolyte on the already formed SEI film.

Further comparison of the test data between Embodiment 2 and Embodiment 3 reveals that: When the content of vinylene carbonate in the first electrolyte is higher than that in the second electrolyte in the two-step electrolyte injection formulation, due to the fact that the main components of the SEI film depend on the additives in the first electrolyte, an excessively high content of vinylene carbonate may result in an increase in interface impedance, thereby affecting cycle performance and energy efficiency. However, it can also enhance the capacity retention and recovery rate under high-temperature storage conditions. This conclusion is further verified in the comparison between Embodiment 6 and Embodiment 7, indicating that optimizing the content of vinylene carbonate in the first electrolyte requires a balance between cycle performance, energy efficiency, and high-temperature storage performance.

On the other hand, by comparing the performance of Embodiment 4, Embodiment 5, Embodiment 6, and Embodiment 2, it was found that adding 1,3-propane sultone, fluoroethylene carbonate, or a combination of the two to the first electrolyte can effectively improve the cycle performance at both room and high temperatures. 1,3-propane sultone is particularly effective in improving high-temperature storage performance, but it may slightly reduce energy efficiency. These results conform to the characteristics of 1,3-propane sultone which enhances the compactness and stability of the SEI film, and the characteristics of fluoroethylene carbonate which improves low-temperature performance and energy efficiency. In summary, the combined use of fluoroethylene carbonate and 1,3-propane sultone (as proposed in Embodiment 6) can effectively combine the advantages of both additives, demonstrating superior comprehensive performance in multiple performance indicators, thereby providing strong support for the overall improvement of battery performance.

By comparing the combinations of Embodiment 4/Embodiment 8, Embodiment 5/Embodiment 9, and Embodiment 6/Embodiment 10, the impact of distribution of additives in the first electrolyte and the second electrolyte was deeply explored. The experimental results once again verified the previous findings regarding the dosage of vinylene carbonate. Under the premise of a constant total additive dosage, the nature and amount of additives in the first electrolyte play a decisive role in the formation of the SEI film and the overall battery performance. Specifically, when 1,3-propane sultone is added to the first electrolyte (Embodiment 4 compared to Embodiment 8), the high-temperature storage and high-temperature cycle performance of the battery are significantly improved, but the room temperature cycling and energy efficiency slightly decrease. In contrast, the addition of fluoroethylene carbonate (Embodiment 5 compared to Embodiment 9) to the first electrolyte improved the cycle performance at both normal and high temperatures, but had a slight negative impact on high-temperature storage and energy efficiency. This conforms to the known characteristics of interface repair and cycle enhancement of fluoroethylene carbonate. It is noteworthy that when both fluoroethylene carbonate and 1,3-propane sultone are added to the first electrolyte (Embodiment 6 compared to Embodiment 10), the battery performance exhibits a comprehensive optimization effect. Apart from a slight decrease in energy efficiency, significant improvements are observed in both cycle performance and storage stability.

By comparing the experimental results of Embodiment 10, Embodiment 11, Embodiment 12, Embodiment 13, and Embodiment 14, the effectiveness of adding infiltrant stabilizers in different electrolytes was systematically evaluated. The data indicates that the addition of the infiltrant stabilizer, whether in the first electrolyte or the second electrolyte, can significantly enhance the battery's performance in both normal temperature cycling and high temperature cycling, and also positively impact high temperature storage performance to a certain extent. However, it is worth noting that the addition of the infiltrant stabilizer also resulted in a slight decrease in energy efficiency. Unlike additives such as 1,3-propane sultone and fluoroethylene carbonate, which directly participate in the formation of the SEI film, the primary mechanism of action of infiltrant stabilizers is to improve the wettability of the surface of the electrode sheet, rather than directly participating in the formation process of the SEI film. Therefore, the difference between the effect of adding infiltrant stabilizers in the first electrolyte and the effect of adding infiltrant stabilizers in the second electrolyte is relatively small. Nevertheless, experimental results indicate that adding infiltrant stabilizers in the second electrolyte (Embodiment 11 and Embodiment 12) enable more infiltrant stabilizers to exist in a free state and thereby function more effectively, achieving more ideal comprehensive performance.

When comparing Embodiment 6 with Embodiment 15, despite using the same electrolyte formulation, adverse effects were observed in various tests, including room and high temperature cycling, high temperature storage, and energy efficiency, when the electrolyte injection volume was reduced. This is primarily due to the reduction in the electrolyte injection volume, which results in a series of issues such as drying and lithium precipitation, thereby negatively affecting battery performance. However, when comparing Embodiment 15 with Embodiment 16 and Embodiment 17, despite maintaining the same electrolyte injection volume and adding infiltrant stabilizers, their performance was comparable to that in the high electrolyte injection volume state, which demonstrates that the infiltrant stabilizers can still play a positive role under low electrolyte injection volume conditions and achieve excellent long-cycle performance.

In addition, to verify whether the replenishment treatment improved the consistency and quality of the batteries, 30 batteries that did not undergo replenishment treatment were retained in the experiment. That is, for these 30 batteries, operation 205 mentioned above was skipped, and the other steps were the same as those in Embodiment 2 mentioned above. Compared to the 30 batteries that did not undergo replenishment treatment, Embodiment 2, which underwent replenishment treatment, exhibited better consistency. The batteries corresponding to Embodiment 2 demonstrated superior capacity distribution and K value after preparation. Here, the K value refers to the voltage drop of the battery per unit time, which is an indicator used to measure the self-discharge rate of lithium batteries.

Those of ordinary skill in the art can understand that the aforementioned embodiments are specific examples for implementing the present disclosure. In practical applications, various modifications can be made to them in form and detail without deviating from the spirit and scope of the present disclosure. A person skilled in the art may make various alterations and modifications without departing from the spirit and scope of the present disclosure, and thus the scope of protection of the present disclosure should be determined by the scope of the appended claims.

What is claimed is:

1. A method for preparing lithium-ion batteries, comprising:
providing a positive electrode sheet, a negative electrode sheet, and a separator;
winding or sheet-stacking the positive electrode sheet, the negative electrode sheet, and the separator, and then placing them into a case to form an initial cell, wherein the separator is positioned between the positive electrode sheet and the negative electrode sheet;
injecting a first electrolyte into the initial cell, wherein the first electrolyte comprises:
0.5 wt % to 2 wt % vinylene carbonate, 5 wt % to 15 wt % lithium salt, and non-aqueous organic solvent (all by weight);
performing a formation process on the initial cell to form an initial solid electrolyte interphase (SEI) film; and
injecting a second electrolyte into the initial cell, wherein the second electrolyte comprises: 5 wt % to 20 wt % vinylene carbonate, 5 wt % to 15 wt % lithium salt, 0.005 wt % to 30 wt % infiltrant stabilizer, and non-aqueous organic solvent (all by weight);
wherein the first electrolyte or the second electrolyte further comprises: at least one of 1,3-propane sultone or fluoroethylene carbonate, wherein an amount of 1,3-propane sultone is within a range of 0.1 wt % to 2 wt % by weight, and an amount of fluoroethylene carbonate is within a range of 0.1 wt % to 2 wt % by weight.

2. The method for preparing lithium-ion batteries according to claim 1, wherein the first electrolyte comprises 0.1 wt % to 2 wt % 1,3-propane sultone and 0.1 wt % to 2 wt % fluoroethylene carbonate.

3. The method for preparing lithium-ion batteries according to claim 1, wherein the lithium salt is selected from lithium perchlorate (LiClO4), lithium tetrafluoroborate (LiBF4), lithium hexafluoroarsenate (LiAsF6), and lithium hexafluorophosphate (LiPF6).

4. The method for preparing lithium-ion batteries according to claim 1, wherein the first electrolyte further comprises at least one of positive electrode film-forming agent or negative electrode film-forming agent.

5. The method for preparing lithium-ion batteries according to claim 4, wherein an amount of the positive electrode film-forming agent is within a range of 0.1 wt % to 0.3 wt %, 0.3 wt % to 0.5 wt %, 0.5 wt % to 2 wt %, 2 wt % to 3 wt %, 3 wt % to 4 wt %, or 4 wt % to 5 wt %.

6. The method for preparing lithium-ion batteries according to claim 4, wherein the positive electrode film-forming agent is at least one of lithium difluorophosphate, 1,5,2,4-dioxadithiane 2,2,4,4-tetraoxide, 1,3,2-dioxathiolane 2,2-dioxide, prop-1-ene-1,3-sultone, tris(trimethylsilyl) borate, tris(trimethylsilyl) phosphate, 1H-Imidazole-1-carboxylicacid, 2-propynylester(9CI), triallyl isocyanurate, 2,4-toluene diisocyanate, 2-phenyl-1-yl 1H-imidazole-1-sulfonic acid ester, hexamethylene diisocyanate, lithium bis[ethanedioato(2-)-κO1,κO2]difluorophosphate(1-), 2-fluoropyridine, lithium bis(oxalate) borate, or lithium difluoro(oxalato)borate(1-).

7. The method for preparing lithium-ion batteries according to claim 4, wherein an amount of the negative electrode film-forming agent is within a range of 0.1 wt % to 0.3 wt %, 0.3 wt % to 0.5 wt %, 0.5 wt % to 2 wt %, or 2 wt % to 3 wt %.

8. The method for preparing lithium-ion batteries according to claim 4, wherein the negative electrode film-forming agent is at least one of 1,3,2-dioxathiolane 2,2-dioxide, 1,5,2,4-dioxadithiane 2,2,4,4-tetraoxide, lithium difluoro(oxalato)borate(1-), propylene sulfate, lithium bis[ethanedioato(2-)-κO1,κO2]difluorophosphate(1-), tris(trimethylsilyl) phosphate, lithium bis(oxalato) borate, 1,3-propylene disulfonic acid methyl ester, and trimethylsilyl phosphate.

9. The method for preparing lithium-ion batteries according to claim 4, wherein the first electrolyte comprises 0.5 wt % to 2 wt % vinylene carbonate, 5 wt % to 15 wt % lithium salt, 0.5 wt % to 3 wt % positive electrode film-forming agent, and non-aqueous organic solvent (all by weight).

10. The method for preparing lithium-ion batteries according to claim 4, wherein the first electrolyte comprises 0.5 wt % to 2 wt % vinylene carbonate, 5 wt % to 15 wt % lithium salt, 0.5 wt % to 2 wt % negative electrode film-forming agent, and non-aqueous organic solvent (all by weight).

11. The method for preparing lithium-ion batteries according to claim 4, wherein the first electrolyte comprises 0.5 wt % to 2 wt % vinylene carbonate, 5 wt % to 15 wt % lithium salt, 0.5 wt % to 3 wt % positive electrode film-forming agent, 0.5 wt % to 2 wt % negative electrode film-forming agent and non-aqueous organic solvent (all by weight).

12. The method for preparing lithium-ion batteries according to claim 1, wherein the non-aqueous organic solvent of the first electrolyte comprises two or more of ethyl methyl carbonate, dimethyl carbonate, diethyl carbonate, methyl ethyl carbonate, ethyl acetate, n-propyl acetate, methyl propionate, methyl acetate, ethyl propionate, propyl propionate, ethyl butyrate, methyl propyl carbonate, propylene carbonate, γ-butyrolactone, and γ-valerolactone.

13. The method for preparing lithium-ion batteries according to claim 1, wherein after performing the formation process on the initial cell and before injecting the second electrolyte into the initial cell, the method further comprises: performing a replenishment treatment on the initial cell, wherein the first electrolyte is replenished into the initial cell.

14. The method for preparing lithium-ion batteries according to claim 13, wherein before performing the formation process on the initial cell, the method comprises:
weighing the initial cell to obtain a first mass of the initial cell; and
after performing the formation process on the initial cell, the method comprises:
weighing the initial cell again to obtain a second mass of the initial cell;
wherein a mass of the first electrolyte replenished during the replenishment treatment is a difference between the first mass and the second mass.

15. The method for preparing lithium-ion batteries according to claim 1, wherein the infiltrant stabilizer is selected from: one of poly(ethyleneglycol) 2-[ethyl[(heptadecafluorooctyl)sulfonyl]amino]ethyl ether, 2-(N-Ethylperfluorooctanesulfonamido)ethyl methacrylate, fluorobenzene, 2,2,3,3-tetrafluoro-1-(1,1,2,2-tetrafluoroethoxy)propane, hexafluoropropyl ethylene glycol, and trifluoro(trifluoromethyl)oxirane.

16. The method for preparing lithium-ion batteries according to claim 1, wherein the first electrolyte comprises: at least one of positive electrode film-forming agent or negative electrode film-forming agent, where an amount of the positive electrode film-forming agent is within a range of 0.5 wt % to 3 wt % by weight, and an amount of the negative electrode film-forming agent is within a range of 0.5 wt % to 2 wt % by weight.

17. The method for preparing lithium-ion batteries according to claim 1, wherein the first electrolyte accounts for 65 wt % to 90 wt % by weight of a total mass of the first electrolyte and the second electrolyte.

18. The method for preparing lithium-ion batteries according to claim 1, wherein an injection volume of the first electrolyte is within a range of 3.5 g/Ah to 4 g/Ah; and an injection volume of the second electrolyte is within a range of 3.5 g/Ah to 4 g/Ah.

19. The method for preparing lithium-ion batteries according to claim 1, wherein the formation process comprises: first high-temperature standing, negative-pressure formation, and aging standing.

20. The method for preparing lithium-ion batteries according to claim 19, wherein after injecting the second electrolyte into the initial cell, the method comprises: performing a second high-temperature standing process on the initial cell, wherein a temperature of the second high-temperature standing process is higher than that of the first high-temperature standing process.
